(19) United States
(12) Patent Application Publication
(10) Pub. No.: US 2011/0135963 A1
(43) Pub. Date: Jun. 9, 2011

(54) METHOD FOR MANUFACTURING GLASS SUBSTRATE FOR DATA STORAGE MEDIUM AND GLASS SUBSTRATE

(75) Inventors: Tatsuo NAGASHIMA, Tokyo (JP); Tetsuya Nakashima, Tokyo (JP)

(73) Assignee: ASAHI GLASS COMPANY. LIMITED, Chiyoda-ku (JP)

(21) Appl. No.: 12/961,838

(22) Filed: Dec. 7, 2010

(30) Foreign Application Priority Data
Dec. 8, 2009 (JP) 2009-278572

(51) Int. Cl. G11B 5/62; G11B 5/73; C03C 17/00

(52) U.S. Cl. 428/836; 65/30.1; 428/846.3

(57) ABSTRACT

The present invention relates to a method for manufacturing a glass substrate for data storage mediums, the method including a chemical strengthening treatment step of dipping a glass for a substrate including, in terms of mol % on the basis of oxides, from 58 to 66% of SiO₂, from 9 to 15% of Al₂O₃, from 7 to 15% of Li₂O and from 2 to 9% of Na₂O, provided that Li₂O+Na₂O is from 13 to 21%, in a mixed molten salt to form a compressive layer on front and back surfaces of the glass for a substrate, in which the mixed molten salt includes, in terms of mass percent, from 1 to 7.5% of lithium nitrate, from 28 to 55% of sodium nitrate and from 40 to 69% of potassium nitrate.

### FIELD OF THE INVENTION

The present invention relates to a method for manufacturing a glass substrate to be used for data storage mediums such as magnetic disk and optical disk, and a glass substrate.

### BACKGROUND OF THE INVENTION

As the glass for a substrate of data storage mediums such as magnetic disk and optical disk (hereinafter sometimes referred to as “the glass for a substrate”), for example, lithium-containing aluminosilicate-based glass having a high Young's modulus or glass obtained by subjecting it to a chemical strengthening treatment (see, for example, Patent Document 1) is used.

In recent years, with an increase in the storage capacity of a hard disk drive, the trend for high recording density proceeds at high pace, and requirements for disk flutter characteristics or impact characteristics during operation are becoming severer. Furthermore, along with smaller diameter of a hard disk drive, the requirement for impact characteristics at the non-operation time is also strong. In order to meet these requirements, a chemical strengthening treatment is applied to the main surface or the like of the glass for a substrate to form a compressive stress layer thereon with an attempt to enhance the strength (see, for example, Patent Document 2).

However, as the recording density increases, not only the demand for strength but also the demands for accuracy of the surface condition (e.g., scratch, attachment) on the main surface of a glass and for accuracy of the disk shape such as flatness, waviness and roughness grow stringent each year, and the change in the surface condition or disk shape due to a chemical strengthening treatment applied becomes a problem.

Therefore, for example, as in Patent Document 3, lap polishing or precise polishing is performed after chemical strengthening, and at the final cleaning, removal of deposits attributable to contaminations contained in a chemical strengthening salt or a strengthening salt is devised.

Patent Document 1: JP-A-2001-180969

Patent Document 2: JP-A-10-198942

Patent Document 3: JP-A-2006-324006

### SUMMARY OF THE INVENTION

The chemical strengthening treatment is by itself a process imposing a load in the production process of a glass substrate for data storage mediums. When polishing or a special cleaning process is applied after the chemical strengthening treatment, this imposes a larger load and may put pressure on the manufacturing process.

Accordingly, an object of the present invention is to provide a manufacturing method of a glass substrate for data storage mediums, where both enhancement of the strength and stabilization of the disk shape are satisfied even without applying a special treatment after chemical strengthening treatment, and a glass substrate for data storage mediums.

As a result of studies to attain the above-described object, the present inventors have found that, by a method for manufacturing glass for data storage mediums, where the composition of the glass for a substrate and the composition of the chemical strengthening molten salt are used in good combination, both enhancement of the strength and stabilization of the disk shape can be satisfied even without applying a special treatment after chemical strengthening treatment.

That is, it has been found that when a glass for a substrate having a specific composition is subjected to a chemical strengthening treatment by using a mixed molten salt containing an appropriate amount of lithium nitrate, the change in the glass shape after chemical strengthening treatment is suppressed and the strengthening is sufficiently achieved. Here, the technique of adding lithium nitrate to a mixed molten salt is described in JP-A-2004-259402, but with the extremely small amount, the effect of suppressing the change in the shape was not recognized, though the stability of strengthening was maintained.

Accordingly, the present invention relates to the following items.

1. A method for manufacturing a glass substrate for data storage mediums, the method comprising a chemical strengthening treatment step of dipping a glass for a substrate comprising, in terms of mol % on the basis of oxides, from 58 to 66% of SiO₂, from 9 to 15% of Al₂O₃, from 7 to 15% of Li₂O and from 2 to 9% of Na₂O, provided that Li₂O+Na₂O is from 13 to 21%, in a mixed molten salt to form a compressive layer on front and back surfaces of the glass for a substrate,

wherein the mixed molten salt comprises, in terms of mass percent, from 1 to 7.5% of lithium nitrate, from 28 to 55% of sodium nitrate and from 40 to 69% of potassium nitrate.

2. The method for manufacturing a glass substrate for data storage mediums according to item 1, wherein the glass for a substrate subjected to the chemical strengthening treatment has:

a fracture toughness value K_{c} measured by an IF method in accordance with JIS R1607 of 1.2 MPa·m^{1/2} or more;

a value K_{c}/K_{bulk} obtained by dividing the fracture toughness value K_{c} by a fracture toughness value K_{bulk} measured by the IF method before subjecting the chemical strengthening treatment of 1.2 or more;

a flatness of 3 μm or less; and

an arithmetic average waviness (Wa) with cutoff values of 0.4 mm and 5 mm on a surface between a radius of 16 mm and a radius of 28 mm from a center of a 2.5-inch disk of the glass for a substrate, of 0.6 nm or less.

3. A glass substrate for data storage mediums, manufactured by the manufacturing method according to item 1 or 2.

4. A data storage medium comprising the glass substrate for data storage mediums according to item 3 and a magnetic recording layer formed on the glass substrate.

According to the manufacturing method of the present invention, a glass substrate for data storage mediums, where both excellent impact resistance and stabilization of disk shape are satisfied even without applying a special treatment after chemical strengthening treatment, can be obtained.

### DETAILED DESCRIPTION OF THE INVENTION

In the method for manufacturing a glass substrate for data storage mediums of the present invention, the conditions except for the composition of the glass for a substrate used and the chemical strengthening treatment process are not particularly limited and may be appropriately selected, and typically, conventionally known processes can be applied.

For example, raw materials of respective components are blended to obtain the later-described composition, and the blend is melted in a glass melting furnace. The glass is homogenized by bubbling, stirring, addition of a refining agent, or the like, molded into a glass plate having a predetermined thickness by a conventionally known molding method to obtain glass for a substrate, and then annealed.

Examples of the molding method of glass include a float process, a pressing process, a fusion process and a downdraw process. In particular, a float process suited for mass production is preferred. The continuous molding methods other than the float process, that is, a fusion process and a downdraw process, are also preferred.

The molded glass for a substrate is, if desired, subjected to a grinding/polishing treatment and a chemical strengthening treatment, then cleaned and dried to obtain a glass substrate for data storage mediums, having a predetermined shape/size.

The chemical strengthening treatment is a treatment of dipping the glass for a substrate in a mixed molten salt, thereby forming a compressive layer on the front and back surfaces of the glass for a substrate. In the manufacturing method of the present invention, the chemical strengthening treatment may be performed after the grinding/polishing treatment, or while the chemical strengthening treatment is first performed, the grinding/polishing treatment may be then performed. It is also possible to perform the chemical strengthening treatment when the grinding/polishing treatment has proceeded to a certain stage, and then perform the remaining process of the grinding/polishing treatment.

The cleaning and drying process is not particularly limited and, for example, the glass is cleaned in sequence with a neutral detergent and pure water by applying an ultrasonic wave in a multi-bath cleaning tank and dried by spin drying. Also, warm water may be used instead of a neutral detergent, or the glass after washing with pure water may be passed through an IPA (isopropyl alcohol) cleaning bath and after IPA vapor drying, pulled up to obtain the glass substrate.

The thus-obtained glass substrate for data storage mediums of the present invention is preferably a circular glass plate having a thickness of typically from 0.5 to 1.5 mm and a diameter of 48 to 93 mm. Also, in the case of a glass substrate for magnetic disks and the like, it is usually preferred to core a hole having a diameter of 15 to 25 mm in the center of the glass substrate.

### [Glass for a Substrate]

### (Composition)

The composition of the glass for a substrate for use in the manufacturing method of the present invention is described below. Unless otherwise indicated, the content of each component is shown in terms of mol percent.

### (1) SiO₂

SiO₂ is a component forming the network of the glass for a substrate and is essential. The content of SiO₂ in the glass for a substrate is 58% or more, preferably 61% or more, and is 66% or less.

If the content of SiO₂ in the glass for a substrate is less than 58%, the acid resistance or weather resistance is reduced, the density (d) is increased, the glass is readily scratched, or the liquidus temperature (T_{L}) rises to make the glass unstable, whereas if the content exceeds 66%, the melting temperature and the temperature (T₄) at which the viscosity becomes 10⁴ dPa·s rise, making it difficult to dissolve and mold the glass, the Young's modulus (E) or specific modulus (E/d) decreases, or the average coefficient of linear expansion (α) at −50 to 70° C. of the glass becomes small.

In the case of wishing to more increase the acid resistance of the glass for a substrate, the content of SiO₂ in the glass for a substrate is preferably 62% or more, more preferably 62.5% or more, still more preferably 63.5% or more.

### (2) Al₂O₃

Al₂O₃ is a component having an effect of increasing Tg, weather resistance and Young's modulus and furthermore, enhancing the ion exchangeability in chemical strengthening and is essential. The content of Al₂O₃ in the glass is 9% or more, preferably 11.5% or more, and is 15% or less, preferably 14% or less.

If the content of Al₂O₃ in the glass is less than 9%, the above-described effect is small and even when chemical strengthening is applied, sufficiently high impact resistance may not be obtained, whereas if the content exceeds 15%, the melting temperature and T₄ rise, making it difficult to dissolve and mold the glass for a substrate, and α may become small or T_{L} may become too high.

In the case of wishing to more enhance the acid resistance, the content of Al₂O₃ in the glass for a substrate is preferably 15% or less, more preferably 14% or less. In the case of wishing to enhance particularly the acid resistance, it is preferred to set the content of SiO₂ in the glass for a substrate to 63.5% or more and set the content of Al₂O₃ to 14% or less.

### (3) Li₂O

Li₂O has an effect of increasing E, E/d or α and at the same time, enhancing the melting character of the glass for a substrate and is essential because the main ion exchange for chemical strengthening in the present invention is exchange from Li⁺ to Na⁺. The content of Li₂O in the glass for a substrate is 7% or more, preferably 9% or more, more preferably 10% or more, and is 15% or less, preferably 14% or less, more preferably 13% or less.

If the content of Li₂O in the glass for a substrate is less than 7%, the above-described effect is small, whereas if the content exceeds 16%, the acid resistance or weather resistance is reduced or Tg becomes low.

### (4) Na₂O

Na₂O is essential because of its effect of increasing a and at the same time, enhancing the melting character of the glass for a substrate. The content of Na₂O in the glass for a substrate is 2% or more, preferably 3% or more, and is 9% or less, preferably 7.5% or less, more preferably 7% or less.

If the content of Na₂O in the glass for a substrate is less than 2%, the above-described effect is small, whereas if the content exceeds 9%, strengthening may be difficult to achieve when performing the chemical strengthening treatment, the acid resistance or weather resistance may be reduced, or Tg may become low.

### (5) Li₂O+Na₂O

The total of Li₂O and Na₂O contents in the glass for a substrate is 13% or more, preferably 14% or more, and is 21% or less, preferably 20% or less.

If the total of Li₂O and Na₂O contents in the glass for a substrate is less than 13%, strengthening is difficult to achieve when performing the chemical strengthening treatment, a becomes small, or the melting character of the glass is reduced, whereas if the content exceeds 21%, the Tg may become too low, stress relaxation may occur to leave no strengthening even when the chemical strengthening treatment is performed, or the acid resistance or weather resistance may be reduced.

### (6) K₂O

K₂O has an effect of making a large or enhancing the melting character of the glass for a substrate. The content of K₂O in the glass for a substrate is preferably 2.5% or more, more preferably 3% or more, and is preferably 8% or less, more preferably 6% or less, still more preferably 5% or less.

If the content of K₂O in the glass for a substrate is less than 2.5%, the weather resistance is reduced, whereas if the content exceeds 8%, strengthening may be difficult to achieve when performing the chemical strengthening treatment, the acid resistance or weather resistance may be reduced, or E or E/d may decrease.

In the case where the glass for a substrate contains K₂O, the value obtained by dividing the content of Li₂O in the glass for a substrate by the total (R₂O) of the Li₂O, Na₂O and K₂O contents is preferably ⅓ or more, more preferably 0.35 or more, still more preferably 0.5 or more.

If the value obtained by dividing the content of Li₂O in the glass for a substrate by the total (R₂O) of the Li₂O, Na₂O and K₂O contents is less than ⅓, strengthening may be difficult to achieve when performing the chemical strengthening treatment, or due to dipping in the molten salt, the strength may become lower than the bulk glass.

### (7) MgO

MgO is not essential but has an effect of raising E, E/d or a while maintaining the weather resistance, making it difficult to scratch the glass for a substrate, and at the same time, enhancing the melting character of the glass for a substrate. The content of MgO in the glass for a substrate is preferably 6% or less, more preferably 5% or less, still more preferably 4% or less. Typically, the content is preferably 1% or more. If the content of MgO in the glass for a substrate exceeds 6%, strengthening is difficult to achieve when performing the chemical strengthening treatment, or T_{L} becomes too high.

### (8) TiO₂

TiO₂ is not essential but has an effect of raising E, E/d or Tg or enhancing the weather resistance. The content of TiO₂ in the glass for a substrate is preferably 4% or less, more preferably 3% or less, still more preferably 2% or less, and is preferably 0.3% or more, more preferably 0.6% or mores, still more preferably 0.8% or more. If the content of TiO₂ in the glass for a substrate exceeds 4%, T_{L} may become too high or a phase separation phenomenon may be likely to occur.

The total of the Al₂O₃, MgO and TiO₂ contents in the glass for a substrate is preferably 12% or more. If this total is less than 12%, it may become difficult to raise E or E/d while maintaining the weather resistance.

### (9) ZrO₂

ZrO₂ is not essential but has an effect of, for example, enhancing the ion exchange rate when the chemical strengthening treatment is performed, increasing E or E/d while maintaining the weather resistance, raising Tg, or enhancing the melting character of the glass for a substrate. The content of ZrO₂ in the glass for a substrate is preferably 3% or less, more preferably 2% or less. If the content exceeds 3%, d may become large to make the glass brittle and at the same time, T_{L} may become too high.

The glass for a substrate for use in the manufacturing method of the present invention is substantially composed of the above-described components but may contain other components within the range not impairing the object of the present invention. In this case, the total content of other components is preferably 5% or less, typically 2% or less.

For example, CaO, SrO or BaO makes a large while maintaining the weather resistance of the glass for a substrate and at the same time, enhances the melting character of the glass for a substrate, and therefore, the glass for a substrate may contain such a component in an amount of up to 5% in total. If the content of CaO, SrO or BaO exceeds 5%, strengthening is difficult to achieve when performing the chemical strengthening treatment, d becomes large, or the glass for a substrate is readily scratched. The content is, in total, preferably 2% or less, typically 1% or less.

The glass for a substrate may contain a refining agent such as SO₃, Cl, As₂O₃, Sb₂O₃ and SnO₂ in an amount of up to 2% in total, and may contain a colorant such as Fe₂O₃, Co₃O₄ and NiO in an amount of up to 2% in total.

Incidentally, B₂O₃ is very likely to volatilize when present together with an alkali metal oxide component and therefore, is preferably not contained in the glass for a substrate, and even if contained, its content is preferably less than 1%, more preferably less than 0.5%.

### (Glass Transition Temperature)

The glass transition temperature (Tg) of the glass for a substrate is preferably 510° C. or more. If it is less than 510° C., the glass temperature may become low for the optimal temperature of the chemical strengthening molten salt and stress relaxation may occur, failing in obtaining sufficient strengthening. The glass transition temperature is more preferably 525° C. or more.

### (Average Coefficient of Linear Expansion)

The average coefficient of linear expansion (α) at −50 to 70° C. of the glass for a substrate is preferably 60×10⁻⁷/° C. or more, more preferably 65×10⁻⁷/° C. or more, still more preferably 70×10⁻⁷/° C. or more, and most preferably 73×10⁻⁷/° C. or more. Typically, the average coefficient of linear expansion is preferably 90×10⁻⁷/° C. or less. If it is less than 60×10⁻⁷/° C., this may be lower than α of the conventionally employed glass for a substrate and since a of the metal for the hub fixed to the substrate is typically 100×10⁻⁷/° C. or more, the difference in a between the hub and the glass for a substrate becomes large, as a result, the glass for a substrate may be easily broken.

### (Viscosity)

In the glass for a substrate, the difference ΔT (=T₄−T_{L}) between the temperature (T₄) at which the viscosity becomes 10⁴ dPa·s and the liquidus temperature (T_{L}) is preferably −70° C. or more, more preferably 0° C. or more, still more preferably 10° C. or more, and most preferably 20° C. or more. If this difference is less than −70° C., it may be difficult to mold the glass for a substrate into a glass plate, and if the difference is less than 0° C., float molding may become difficult.

### (Density)

The density of the glass for a substrate is preferably 2.6 g/cm³ or less, more preferably 2.5 g/cm³ or less. If the density exceeds 2.6 g/cm³, weight reduction of the data recording medium may be hardly realized, the power consumption required for driving the recording medium may increase, the disk may be readily vibrated by the effect of a windage loss during its rotation, leading to an error in reading, or when the recording medium receives a shock, the substrate is likely to be deflected to produce a stress and may be easily broken.

### (Young's Modulus)

The Young's modulus of the glass for a substrate is preferably from 75 to 90 GPa, more preferably 78 GPa or more, and most preferably 80 GPa or more, and is typically 87 GPa or less. If the Young's modulus is less than 75 GPa, the disk may be readily vibrated by the effect of a windage loss during its rotation, leading to an error in reading, or when a recording medium receives a shock, the substrate is likely to be deflected to produce a stress and may be easily broken, whereas if it exceeds 90 GPa, the polishing rate may be reduced, or a local stress may be readily produced to cause breakage.

### [Chemical Strengthening Treatment Step]

### (Mixed Molten Salt)

The mixed molten salt used in the chemical strengthening step of the manufacturing method of the present invention has the following composition. Unless otherwise indicated, the content of each component is shown in terms of mass percent.

### (1) Lithium Nitrate

Lithium nitrate has an effect of, at the ion exchange of Li⁺ in the molten salt, making uniform the in-plane distribution in the strengthening compressive layer of the glass surface layer and acting to suppress the change in shape of the glass after the chemical strengthening treatment and therefore, is essential. The content of lithium nitrate in the mixed molten salt is 1% or more, preferably 2% or more, and is 7.5% or less, preferably 6% or less, more preferably 4% or less.

If the content of lithium nitrate in the mixed molten salt is less than 1%, the above-described effect becomes small, whereas if the content exceeds 7.5%, exchange of Na or K in the glass for a substrate with Li may be conversely accelerated, making it difficult to achieve the strengthening. Also, the surface layer of the glass for a substrate becomes a tensile layer but not a compressive layer, and the strength may become lower than that of the bulk glass.

### (2) Sodium Nitrate

In the manufacturing method of a glass substrate of the present invention, sodium nitrate is essential, because main strengthening is brought about by the ion exchange of Na⁺ in the mixed molten salt with Li in the glass. The content of sodium nitrate in the mixed molten salt is 28% or more and is 55% or less.

If the content of sodium nitrate in the mixed molten salt is less than 28%, chemical strengthening may become difficult to achieve and at the same time, the melting point of the mixed molten salt may rise, making it difficult to handle the mixed molten metal, whereas if the content exceeds 55%, the melting point of the mixed molten salt may rise and handling of the molten salt may become difficult. Also, the shape of the glass may be greatly changed after the chemical strengthening treatment.

### (3) Potassium Nitrate

In the manufacturing method of a glass substrate of the present invention, the rate of ion exchange of K⁻ in the mixed molten salt with Li or Na in the glass is low as compared with the ion exchange of Li and Na and therefore, potassium nitrate is not a main strengthening ion but is essential, because the melting point of the mixed molten salt lowers due to the freezing-point depression and unlike lithium nitrate, it does not occur that when the content is too large, strengthening becomes difficult to achieve. The content of potassium nitrate in the mixed molten salt is 40% or more and 69% or less.

If the content of potassium nitrate in the mixed molten salt is less than 40%, the melting point of the mixed molten salt may rise and handling of the molten salt may become difficult, whereas if the content exceeds 69%, the melting point of the mixed molten salt may rise, making it difficult to handle the molten salt, and at the same time, chemical strengthening may become difficult to achieve.

The mixed molten salt for use in the manufacturing method of the present invention is substantially composed of the above-described components but may contain other components within the range not impairing the object of the present invention. Examples of other components include an alkali sulfate, an alkali chloride salt, an alkaline earth sulfate and an alkaline earth chloride salt, such as sodium sulfate, potassium sulfate, sodium chloride, potassium chloride, calcium sulfate, strontium sulfate, barium sulfate, calcium chloride, strontium chloride and barium sulfate.

The content of these other components in the mixed molten salt is preferably 5% or less, more preferably 1% or less. Within this range, the other components have an effect of preventing volatilization during melting of the molten mixed salt. If the content exceeds 5%, strengthening becomes difficult to achieve when performing the chemical strengthening treatment.

### (Conditions of Chemical Strengthening Treatment)

The chemical strengthening treatment is a treatment of dipping the glass for a substrate in a mixed molten salt, thereby forming a compressive layer on the front and back surfaces of the glass for a substrate. In the manufacturing method of the present invention, the treatment conditions at the chemical strengthening treatment are not particularly limited and may be appropriately selected from conventionally known methods.

### (1) Heating Temperature of Mixed Molten Salt

The heating temperature of the mixed molten salt is preferably 300° C. or more, more preferably 350° C. or more, still more preferably 370° C. or more, and is preferably 450° C. or less, more preferably 430° C. or less.

If the heating temperature of the mixed molten salt is less than 300° C., the ion exchange rate may drop and strengthening may become difficult to achieve, whereas if it exceeds 450° C., the flatness and arithmetic average waviness (Wa) of the later-described glass disk for data storage mediums may be increased by the chemical strengthening treatment.

The upper limit of the heating temperature of the mixed molten salt is preferably less than (Tg-100)° C. of the glass for use in the manufacturing method of the present invention. If the heating temperature exceeds (Tg-100)° C., the glass may not be sufficiently strengthened due to stress relaxation, despite occurrence of ion exchange.

### (2) Preheating Temperature of Glass for Substrate

Before contacting the glass with a mixed molten salt, the glass is preferably preheated at a temperature not lower than the melting point of the mixed molten salt. This is performed to prevent solidification of the molten salt on the glass surface during dipping in the mixed molten salt and suppress reduction in the ion exchange rate or uneven distribution of the compressive layer in the glass plane.

The preheating temperature of the glass for a substrate is preferably less than 400° C., more preferably 350° C. or less. This is because if the preheating temperature is 400° C. or more, the shape may change by the effect of residual stress at the preheating or due to non-uniform temperature in the glass plane, for example, at the contact portion thereof with a sample holder.

### (3) Treating Time

The time for which the glass for a substrate is contacted with the mixed molten salt is preferably 5 minutes or more, more preferably 7 minutes or more, still more preferably 10 minutes or more, and is preferably 2 hours or less, more preferably 1 hour or less, still more preferably 30 minutes or less.

If the time for which the glass for a substrate is contacted with the mixed molten salt is less than 5 minutes, sufficient strengthening may not be achieved, variation of strength may be produced, and the process control may become difficult, whereas if the time exceeds 2 hours, the flatness and arithmetic average waviness (Wa) of the later-described glass disk for data storage mediums may be increased by the chemical strengthening treatment, the takt time in the production process may be reduced, and this may put pressure on the cost.

### (4) Cooling of Glass for Substrate

After the step of contacting the glass for a substrate with the mixed molten salt, the glass for a substrate is preferably, without passing through an annealing step, held for 30 seconds to 2 minutes until its temperature is lowered to 300° C. or less, and then quenched by contacting the glass with a cooling medium. The cooling rate of the glass for a substrate is preferably 100° C./min or more and is preferably 4,000° C./min or less, more preferably 3,000° C./min or less.

If the cooling rate of the glass for a substrate is less than 100° C./min, the molten salt depositing on the glass for a substrate may allow the ion exchange to proceed only at the portion in contact with the molten salt even in the course of cooling, and the distribution of the strengthening layer in the glass plane may become non-uniform, as a result, the flatness and arithmetic average waviness (Wa) of the later-described glass disk for data storage mediums may be increased.

On the other hand, if the cooling rate of the glass for a substrate exceeds 4,000° C./min, the arithmetic average waviness (Wa) and the arithmetic average roughness (Ra) may be increased. Also, if the glass is quenched by contacting it with a cooling medium without passing through holding, the glass for a substrate may be broken due to heat shock. Furthermore, the arithmetic average waviness (Wa) may be increased.

### (Characteristics of Glass for a Substrate Subjected to Chemical Strengthening Treatment and Glass Disk)

The characteristics of the glass for a substrate subjected to the above-described chemical strengthening treatment are described below.

### (1) Fracture Toughness Value K_{c}

In the glass for a substrate subjected to the chemical strengthening treatment, the fracture toughness value K_{c} measured by the IF method in accordance with JIS R1607 is preferably 1.2 MPa·m^{1/2} or more, more preferably 1.4 MPa·m^{1/2} or more, still more preferably 1.6 MPa·m^{1/2} or more. If K_{c} of the glass for a substrate is less than 1.2 MPa·m^{1/2}, sufficiently high impact resistance may not be obtained.

### (2) K_{c}/K_{bulk}

In the glass for a substrate subjected to the chemical strengthening treatment, the value K_{c}/K_{bulk} obtained by dividing the fracture toughness value above by the fracture toughness value K_{bulk} measured by the IF method before the chemical strengthening treatment is preferably 1.2 or more, more preferably 1.5 or more, still more preferably 2.0 or more. If K_{c}/K_{bulk} of the glass for a substrate is less than 1.2, the need to apply the chemical strengthening treatment is meaningless.

### (3) Flatness

In the glass for a substrate subjected to the chemical strengthening treatment, the flatness is preferably 3 μm or less. The flatness as used herein indicates, for example, in the case of a 2.5-inch disk, the Peak-Valley value in the entire area between a radius of 13 mm and a radius of 32.5 mm from the center of the disk. If the flatness of the glass disk for data storage mediums exceeds 3 μm, the vibration and amplitude during rotation of the disk may be increased.

### (4) Arithmetic Average Waviness (Wa)

In the glass for a substrate subjected to the chemical strengthening treatment, the arithmetic average waviness (Wa) is preferably 0.6 nm or less, more preferably 0.5 nm or less. Here, in the case of a 2.5-inch disk, Wa indicates the arithmetic average waviness with cutoff values of 0.4 mm and 5 mm on the surface between a radius of 16 mm and a radius of 28 mm from the center of the disk. If Wa of the glass disk for data storage mediums exceeds 0.6 nm, head crash may occur.

### [Data Storage Medium]

In the data storage medium of the present invention, at least a magnetic layer that is a magnetic recording layer is formed on the main surface of the glass substrate for data storage mediums of the present invention and in addition, an underlayer, a protective layer, a lubricating layer, an unevenness control layer and the like may be formed, if desired.

Examples of the magnetic layer include a Co system such as Co—Cr, Co—Cr—Pt, Co—Ni—Cr, Co—Ni—Cr—Pt, Co—Ni—Pt and Co—Cr—Ta.

Examples of the underlayer provided under the magnetic layer so as to enhance the durability or magnetic property include an Ni layer, an Ni—P layer, a Cr layer and an SiO₂ layer. A Cr layer, a Cr alloy layer, or a metal or alloy layer composed of other materials may be provided on or below the magnetic layer.

Examples of the protective layer include a carbon or silica layer having a thickness of 50 to 1,000 Å. Also, in order to form a lubricating layer, for example, a perfluoropolyether-based liquid lubricant in a thickness of about 30 Å can be used.

### EXAMPLES

The present invention is described below by referring to Examples, but the present invention is not limited thereto.

### [Glass for Substrate]

Compositions of glasses for a substrate 1 to 21 used are shown in Tables 1 and 2.

With respect to glasses for a substrate 1 to 3 in Table 1, a glass plate obtained by a float process was used.

With respect to the glasses for a substrate 1 to 3 in Table 1, the glass was cut into a disk shape having an inner diameter of 20 mm and an outer diameter of 65 mm and then subjected to a lapping step, a polishing step using cerium oxide, a final polishing step using colloidal silica, and a cleaning step, and the obtained 2.5-inch disk having a thickness of 0.635 mm, a flatness of 3 μm or less, Wa of 0.60 nm or less, and Ra of 0.15 nm or less was used as the sample for K_{bulk} (unit: MPa·m^{1/2}) and chemical strengthening treatment. In Table 1, “Disk” indicates the sample prepared in this way.

With respect to the glasses for a substrate 4 to 16 in Tables 1 and 2, raw materials were prepared and mixed to obtain a composition shown in terms of mol percent in the columns from SiO₂ to K₂O, and the mixture was melted in a platinum crucible at a temperature of 1,550 to 1,650° C. for 3 to 5 hours. Subsequently, the molten glass was cast to form a plate and then annealed to prepare a glass for a substrate.

With respect to the glass of the glasses for a substrate 4 to 16 in Tables 1 to 2, both surfaces of a glass plate having a thickness of 0.8 to 1 mm and a size of 4 cm×4 cm were mirror-polished with cerium oxide and then cleaned with calcium carbonate and a neutral detergent, and the obtained plate was used as the sample for K_{bulk} and chemical strengthening treatment. In Tables 1 and 2, “Plate” indicates the sample prepared in this way.

With respect to the glass of the glasses for a substrate 17 to 21 in Table 2, the value in the parenthesis shown in Table 2 and Table 6 later was determined by the regression calculation. In Table 2, “Cal” indicates that the estimate value was obtained in this way.

TABLE 1

| | Glass for Substrate | | | | | | | | | |
|---|---|---|---|---|---|---|---|---|---|---|
| | 1 | 2 | 3 | 4 | 5 | 6 | 7 | 8 | 9 | 10 |
| SiO₂ | 61.9 | 64.5 | 72 | 66.3 | 62 | 62 | 62 | 62 | 62 | 62 |
| Al₂O₃ | 13 | 12 | 1.1 | 8.5 | 13 | 13 | 13 | 13 | 13 | 13 |
| MgO | 3 | 0 | 5.5 | 0 | 3 | 3 | 3 | 3 | 3 | 3 |
| CaO | 0 | 0 | 8.6 | 0 | 0 | 0 | 0 | 0 | 0 | 0 |
| TiO₂ | 1 | 0 | 0 | 0 | 0 | 0 | 0 | 0 | 0 | 0 |
| ZrO₂ | 0.6 | 1.8 | 0 | 2.7 | 2 | 2 | 2 | 2 | 2 | 2 |
| Li₂O | 10.7 | 12.8 | 0 | 11.6 | 10 | 5 | 5 | 6.7 | 7.5 | 9 |
| Na₂O | 6.8 | 5.5 | 12.6 | 10.9 | 5 | 10 | 5 | 6.7 | 7.5 | 6 |
| K₂O | 3 | 3.4 | 0.2 | 0 | 5 | 5 | 10 | 6.6 | 5 | 5 |
| R₂O | 20.5 | 21.7 | 12.8 | 22.5 | 20 | 20 | 20 | 20 | 20 | 20 |
| Li + Na | 17.5 | 18.3 | 12.6 | 22.5 | 15 | 15 | 10 | 13.4 | 15 | 15 |
| Li/R₂O | 0.52 | 0.59 | 0.00 | 0.52 | 0.50 | 0.25 | 0.25 | 0.34 | 0.38 | 0.45 |
| Tg | 520 | 514 | 550 | 490 | 556 | 569 | 588 | 563 | 557 | 553 |
| α | 73 | 74 | 72 | 73 | 73 | 80 | 83 | 80 | 76 | 74 |
| d | 2.47 | 2.47 | 2.50 | 2.50 | 2.49 | 2.51 | 2.50 | 2.50 | 2.50 | 2.50 |
| E | 83.2 | 82.7 | 83.1 | 84.0 | 84.3 | 81.4 | 79.0 | 81.6 | 83.0 | 83.8 |
| E/d | 33.7 | 33.5 | 28.8 | 33.6 | 33.8 | 32.5 | 31.6 | 32.7 | 33.2 | 33.6 |
| T₄ | 1087 | 1093 | 1040 | — | — | — | — | — | — | — |
| T_{L} | <960 | 1050 | 1020 | — | <1040 | — | — | — | — | — |
| K_{bulk} | 0.94 | 0.93 | 0.78 | 0.88 | 0.89 | 0.78 | 0.72 | 0.81 | 0.85 | 0.83 |
| Mode | Disk | Disk | Disk | Plate | Plate | Plate | Plate | Plate | Plate | Plate |

(in mol % on the oxide basis)

TABLE 2

| | Glass for Substrate | | | | | | | | | | |
|---|---|---|---|---|---|---|---|---|---|---|---|
| | 11 | 12 | 13 | 14 | 15 | 16 | 17 | 18 | 19 | 20 | 21 |
| SiO₂ | 63.5 | 65 | 57 | 64 | 60 | 64 | 65.5 | 58.5 | 60 | 62 | 60 |
| Al₂O₃ | 11.5 | 10 | 13 | 13 | 13 | 13 | 9.5 | 14.5 | 13 | 14 | 14 |
| MgO | 3 | 3 | 3 | 3 | 5 | 3 | 3 | 3 | 3 | 2 | 0 |
| CaO | 0 | 0 | 0 | 0 | 0 | 0 | 0 | 0 | 0 | 0 | 0 |
| TiO₂ | 0 | 0 | 0 | 0 | 0 | 0 | 0 | 0 | 0 | 0 | 0 |
| ZrO₂ | 2 | 2 | 2 | 2 | 2 | 0 | 3 | 2 | 2 | 3 | 3 |
| Li₂O | 10 | 10 | 12.5 | 9 | 10 | 10 | 10 | 10 | 10 | 14 | 11 |
| Na₂O | 5 | 5 | 6.25 | 4.5 | 5 | 5 | 4 | 7 | 9 | 2 | 9 |
| K₂O | 5 | 5 | 6.25 | 4.5 | 5 | 5 | 5 | 5 | 3 | 3 | 3 |
| R₂O | 20 | 20 | 25 | 18 | 20 | 20 | 19 | 22 | 22 | 19 | 23 |
| Li + Na | 15 | 15 | 18.75 | 13.5 | 15 | 15 | 14 | 17 | 19 | 16 | 20 |
| Li/R₂O | 0.50 | 0.50 | 0.50 | 0.50 | 0.50 | 0.50 | 0.53 | 0.45 | 0.45 | 0.74 | 0.48 |
| Tg | 537 | 519 | 508 | 584 | 557 | 519 | (535) | (525) | (511) | (518) | (508) |
| α | 73 | 73 | 83 | 68 | 73 | 72 | (68.2) | (78.0) | (75.8) | (61.1) | (75.4) |
| d | 2.49 | 2.46 | 2.59 | 2.50 | 2.48 | 2.44 | (2.51) | (2.51) | (2.52) | (2.52) | (2.53) |
| E | 83.7 | 82.4 | 88.4 | 84.9 | 84.0 | 82.8 | (85.7) | (85.3) | (86.1) | (92.2) | (84.2) |
| E/d | 33.6 | 33.4 | 34.2 | 33.9 | 33.9 | 33.9 | (34.1) | (33.9) | (34.2) | (36.6) | (34.4) |
| T₄ | — | — | — | — | — | — | — | — | — | — | — |
| T_{L} | — | — | — | — | — | — | — | — | — | — | — |
| K_{bulk} | 0.87 | 0.88 | 0.81 | 0.89 | 0.85 | 0.96 | (0.9) | (0.9) | (0.8) | (1.0) | (0.8) |
| Mode | Plate | Plate | Plate | Plate | Plate | Plate | Cal | Cal | Cal | Cal | Cal |

(in mol % on the oxide basis)

### [Mixed Molten Salt]

In Tables 3 and 4, compositions of mixed molten salts 1 to 17 used for the chemical strengthening treatment are shown. With respect to the mixed molten salts 1 to 17 in Tables 3 and 4, from 1 to 2 kg of raw materials were prepared and mixed to obtain a composition shown in terms of mass percent in the columns from lithium nitrate to potassium nitrate, and the mixture was melted at 450° C. by using an SUS-made vessel, stirred, then held at a predetermined treatment temperature and when the temperature was stabilized, chemically strengthened. Also, in the measurement of the melting point (M.P), a part of the above-described mixed molten salt for chemical strengthening was solidified, then pulverized into a powder and measured by differential scanning calorimetry (DSC). Incidentally, in Tables 3 and 4, “-” indicates that the measurement was not performed.

TABLE 3

| | Mixed Molten Salt | | | | | | | |
|---|---|---|---|---|---|---|---|---|
| | 1 | 2 | 3 | 4 | 5 | 6 | 7 | 8 |
| LiNO₃ | 0.0 | 0.0 | 0.0 | 0.0 | 0.4 | 1.5 | 3.7 | 3.7 |
| NaNO₃ | 0.0 | 21.9 | 45.7 | 71.6 | 45.7 | 51.0 | 41.5 | 31.7 |
| KNO₃ | 100.0 | 78.1 | 54.3 | 28.4 | 53.9 | 47.5 | 54.8 | 64.6 |
| M.P. (° C.) | 335 | 262 | 223 | 251 | — | — | 202 | 215 |

(mass %)

TABLE 4

| | Mixed Molten Salt | | | | | | | | |
|---|---|---|---|---|---|---|---|---|---|
| | 9 | 10 | 11 | 12 | 13 | 14 | 15 | 16 | 17 |
| LiNO₃ | 3.8 | 4.0 | 5.3 | 6.8 | 7.5 | 7.8 | 11.4 | 19.4 | 20.3 |
| NaNO₃ | 51.6 | 41.7 | 42.8 | 44.6 | 37.2 | 57.8 | 32.8 | 23.9 | 50.0 |
| KNO₃ | 44.6 | 54.2 | 52.0 | 48.6 | 55.3 | 34.4 | 55.8 | 56.8 | 29.7 |
| M.P. (° C.) | 213 | — | — | — | 175 | 211 | 137 | 148 | 109 |

(mass %)

### [Evaluation Method]

With respect to the glass for a substrate, Tg (unit: ° C.), α (unit: ×10⁻⁷/° C.), density d (unit: g/cm³), Young's modulus E (unit: GPa), specific modulus E/d (unit: MNm/kg), temperature T₄ at which the viscosity becomes 10⁴ P (unit: ° C.), liquidus temperature T_{L} (unit: ° C.), and K_{bulk} (unit: MPa·m^{1/2}) were measured or evaluated by the following methods.

(1) Glass Transition Temperature (Tg) (unit: ° C.)

Using a differential thermal dilatometer and using quartz glass as a reference sample, the elongation percentage of glass when heated from room temperature at a rate of 5° C./min was measured up to a temperature at which the glass was softened and elongation was no longer observed, that is, a deformation point, and the temperature corresponding to the inflection point in the thermal expansion curve was taken as the glass transition temperature.

(2) Average Coefficient of Linear Expansion (α) (unit: ×10⁻⁷/° C.)

From the thermal expansion curve obtained in the same manner as in the measurement of Tg above after lowering the sample temperature to the vicinity of −150° C. by using liquid nitrogen, the average coefficient of linear expansion in the range of −50 to 70° C. was calculated.

(3) Density (d) (unit: g/cm³)

Measured by the Archimedes method.

(4) Young's Modulus (E) (unit: GPa)

With respect to a glass plate having a thickness of 4 to 10 mm and a size of about 4 cm×4 cm, the Young's modulus was measured by the ultrasonic pulse method.

(5) Temperature (T₄) at which the viscosity becomes 10⁴ P (unit: ° C.)

The temperature at which the viscosity becomes 10⁴ P was measured by a rotation viscometer and designated as T₄.

(6) Liquidus Temperature (T_{L}) (unit: ° C.)

T_{L}: A glass specimen of about 1 cm×1 cm×0.8 cm was placed on a platinum dish and heat-treated for 3 hours in an electric furnace set at every 20° C. in the temperature range of 960 to 1,200° C. The glass was allowed to cool in atmospheric air and then observed by a microscope, and the temperature range where a crystal was precipitated was taken as the liquidus temperature.

(7) Fracture Toughness Value (K_{bulk}) (unit: MPa·m^{1/2})

Using the sample above, the fracture toughness value was determined by the IF method in accordance with JIS R1607. That is, an operation of introducing an indentation mark with an indentation load of 5 kgf for a holding time of 15 seconds by using a Vickers hardness tester and after standing for 15 seconds, measuring the diagonal length of indentation mark and the length of crack by using a microscope attached to the tester, was repeated 10 times, and the fracture toughness value was obtained according to the following formula:

K_{C}=0.026×(E×P)^{1/2}×a×c^{-3/2}

In the formula, E is the Young's modulus and the value measured by the method above was used. Also, P is the indentation load, a is a half of the average diagonal length of the indentation mark, and c is a half of the average crack length.

Furthermore, with respect to the glass for a substrate subjected to the chemical strengthening treatment, K_{c} (unit: MPa·m^{1/2}), flatness (unit: μm) and Wa (unit: nm) were measured or evaluated by the following methods.

(8) Fracture Toughness Value (K_{c}) (unit: MPa·m^{1/2})

Measured in the same manner as in (7).

(9) Flatness (unit: μm)

The Peak-Valley value in the entire area between a radius of 13 mm and a radius of 32.5 mm from the center of the disk was measured using Optiflat.

(10) Arithmetic Average Waviness (Wa) (unit: nm)

The arithmetic average waviness with cutoff values of 0.4 mm and 5 mm on the surface between a radius of 16 mm and a radius of 28 mm from the center of the disk was measured using Optiflat.

### Reference Example 1

Using the mixed molten salt 3 having the composition shown in Table 3, which is a generally employed composition near the eutectic point for sodium nitrate and potassium nitrate, the glasses for a substrate 1 to 16 having the composition shown in Tables 1 to 2 were chemically strengthened at 400° C. for 0.5 hours.

The characteristics of the glass for a substrate subjected to the chemical strengthening treatment and the results are shown in Tables 5 and 6. In Tables 5 and 6, Examples 1 to 21 are Reference Example. Incidentally, in Tables 5 and 6, “-” indicates that the measurement was not performed. Also, in Tables 5 and 6, the value in the parenthesis indicates an estimate value.

TABLE 5

| | Example | | | | | | | | | |
|---|---|---|---|---|---|---|---|---|---|---|
| | 1 | 2 | 3 | 4 | 5 | 6 | 7 | 8 | 9 | 10 |
| Glass for a substrate | 1 | 2 | 3 | 4 | 5 | 6 | 7 | 8 | 9 | 10 |
| Mixed molten salt | 3 | 3 | 3 | 3 | 3 | 3 | 3 | 3 | 3 | 3 |
| Treatment | 400 | 400 | 400 | 400 | 400 | 400 | 400 | 400 | 400 | 400 |
| temperature (° C.) | | | | | | | | | | |
| Treating time (min.) | 30 | 30 | 30 | 30 | 30 | 30 | 30 | 30 | 30 | 30 |
| Preheating | — | — | — | — | — | — | — | — | — | — |
| Condition (° C.) | | | | | | | | | | |
| Annealing/quenching | 1500 | 1500 | 1500 | 1500 | 1500 | 1500 | 1500 | 1500 | 1500 | 1500 |
| condition (° C./min.) | | | | | | | | | | |
| K_{c} (MPa · m^{1/2}) | 1.88 | 1.86 | 0.74 | 1.59 | 1.92 | 1.63 | 0.91 | 1.67 | (1.7) | (1.8) |
| K_{c}/K_{bulk} | 2.0 | 2.0 | 0.95 | 1.81 | 2.16 | 2.09 | 1.26 | 2.06 | (2.0) | (2.2) |
| Mode | Disk | Disk | Disk | Plate | Plate | Plate | Plate | Plate | Plate | Plate |

TABLE 6

| | Example | | | | | | | | | | |
|---|---|---|---|---|---|---|---|---|---|---|---|
| | 11 | 12 | 13 | 14 | 15 | 16 | 17 | 18 | 19 | 20 | 21 |
| Glass for a substrate | 11 | 12 | 13 | 14 | 15 | 16 | 17 | 18 | 19 | 20 | 21 |
| Mixed molten salt | 3 | 3 | 3 | 3 | 3 | 3 | 3 | 3 | 3 | 3 | 3 |
| Treatment | 400 | 400 | 400 | 400 | 400 | 400 | 400 | 400 | 400 | 400 | 400 |
| temperature (° C.) | | | | | | | | | | | |
| Treating time (min.) | 30 | 30 | 30 | 30 | 30 | 30 | 30 | 30 | 30 | 30 | 30 |
| Preheating | — | — | — | — | — | — | — | — | — | — | — |
| Condition (° C.) | | | | | | | | | | | |
| Annealing/quenching | 1500 | 1500 | 1500 | 1500 | 1500 | 1500 | 1500 | 1500 | 1500 | 1500 | 1500 |
| condition (° C./min.) | | | | | | | | | | | |
| K_{c} (MPa · m^{1/2}) | (1.8) | (1.7) | (1.5) | (2.0) | (1.7) | (1.7) | (1.7) | (1.9) | (1.7) | (1.7) | (1.7) |
| K_{c}/K_{bulk} | (2.1) | (1.9) | (1.9) | (2.2) | (2.0) | (1.8) | (1.9) | (2.1) | (2.1) | (1.7) | (2.1) |
| Mode | Plate | Plate | Plate | Plate | Plate | Plate | Cal | Cal | Cal | Cal | Cal |

As seen from Tables 5 and 6, in Examples 1, 2, 5, 9 to 12 and 14 to 21 where a glass for a substrate comprising, in terms of mol % on the basis of oxides, from 58 to 66% of SiO₂, from 9 to 15% of Al₂O₃, from 7 to 15% of Li₂O and from 2 to 9% of Na₂O, provided that Li₂O+Na₂O is from 13 to 21%, was chemically strengthened, the K_{c} value of the glass for a substrate after the chemical strengthening treatment was high as compared with Examples 3, 4, 6 to 8 and 13 where a glass for a substrate not satisfying the conditions above was chemically strengthened. This result reveals that the glass for a substrate comprising, in terms of mol % on the basis of oxides, from 58 to 66% of SiO₂, from 9 to 15% of Al₂O₃, from 7 to 15% of Li₂O and from 2 to 9% of Na₂O, provided that Li₂O+Na₂O is from 13 to 21%, is likely to be strengthened by a chemical strengthening treatment as compared with the glass for a substrate not satisfying the conditions above.

### Example 1

The glasses for a substrate 1 to 16 having the composition shown in Tables 1 and 2 were chemically strengthened using the mixed molten salts 1 to 17 having the composition shown in Tables 3 and 4. As for the treating time and treatment temperature, the treatment was performed under the conditions shown in Tables 7 to 11. The preheating conditions were such that the glass was held at the temperature shown in Tables 7 to 11 for 10 minutes. In the Tables, “-” indicates that the preheating was not performed. The cooling conditions were controlled by the cooling start temperature and cooling medium temperature (e.g., water, warm water) and, if desired, by using an annealing furnace. The characteristics of the glass for a substrate subjected to the chemical strengthening treatment were evaluated, and the results are shown in Tables 7 to 11. In Tables 7 to 11, Examples 6 to 9, 14, 15, 21, 22, 31 to 41 and 44 to 51 are Working Examples of the invention and others are Comparative Examples.

TABLE 7

| | Example | | | | | | | | | |
|---|---|---|---|---|---|---|---|---|---|---|
| | 1 | 2 | 3 | 4 | 5 | 6 | 7 | 8 | 9 | 10 |
| Glass for a substrate | 1 | 1 | 1 | 1 | 1 | 1 | 1 | 1 | 1 | 1 |
| Mixed molten salt | 1 | 2 | 3 | 4 | 5 | 7 | 8 | 9 | 13 | 14 |
| Treatment | 350 | 350 | 350 | 350 | 350 | 350 | 350 | 350 | 350 | 350 |
| temperature (° C.) | | | | | | | | | | |
| Treating time (min.) | 120 | 120 | 120 | 120 | 120 | 120 | 120 | 120 | 120 | 120 |
| Preheating | — | — | — | — | — | — | — | — | — | — |
| Condition (° C.) | | | | | | | | | | |
| Annealing/quenching | 1500 | 1500 | 1500 | 1500 | 1500 | 1500 | 1500 | 1500 | 1500 | 1500 |
| condition (° C./min.) | | | | | | | | | | |
| K_{c} (MPa · m^{1/2}) | 1.18 | 1.96 | 1.83 | 2 | 1.61 | 1.57 | 1.6 | 1.62 | 1.31 | 1.16 |
| K_{c}/K_{bulk} | 1.26 | 2.09 | 1.95 | 2.13 | 1.72 | 1.67 | 1.70 | 1.72 | 1.39 | 1.23 |
| Flatness (μm) | 1.79 | 7.45 | 6.95 | 6.92 | 0.63 | 0.92 | 0.91 | 1.42 | 1.2 | 2.4 |
| Wa (nm) | — | >10.00 | >10.00 | >10.00 | 0.62 | 0.33 | 0.44 | — | — | — |

TABLE 8

| | Example | | | | | | | | | |
|---|---|---|---|---|---|---|---|---|---|---|
| | 11 | 12 | 13 | 14 | 15 | 16 | 17 | 18 | 19 | 20 |
| Glass for a substrate | 1 | 1 | 1 | 2 | 2 | 3 | 3 | 3 | 3 | 3 |
| Mixed molten salt | 15 | 16 | 17 | 7 | 7 | 1 | 2 | 3 | 4 | 7 |
| Treatment | 350 | 350 | 350 | 350 | 400 | 400 | 400 | 400 | 400 | 400 |
| temperature (° C.) | | | | | | | | | | |
| Treating time (min.) | 120 | 120 | 120 | 30 | 30 | 120 | 120 | 120 | 120 | 120 |
| Preheating | — | — | — | 300 | 300 | — | — | — | — | — |
| Condition (° C.) | | | | | | | | | | |
| Annealing/quenching | 1500 | 1500 | 1500 | 1500 | 1500 | 1500 | 1500 | 1500 | 1500 | 1500 |
| condition (° C./min.) | | | | | | | | | | |
| K_{c} (MPa · m^{1/2}) | 0.89 | 0.55 | 0.58 | 1.27 | 1.5 | 0.87 | 0.79 | 0.73 | 0.7 | x |
| K_{c}/K_{bulk} | 0.95 | 0.59 | 0.62 | 1.37 | 1.61 | 1.12 | 1.01 | 0.94 | 0.90 | — |
| Flatness (μm) | 1.7 | 1.05 | 0.97 | 1 | 1.71 | — | — | — | — | — |
| Wa (nm) | — | — | — | 0.43 | 0.47 | — | — | — | — | — |

TABLE 9

| | Example | | | | | | | | | |
|---|---|---|---|---|---|---|---|---|---|---|
| | 21 | 22 | 23 | 24 | 25 | 26 | 27 | 28 | 29 | 30 |
| Glass for a substrate | 5 | 5 | 6 | 6 | 7 | 7 | 7 | 7 | 8 | 8 |
| Mixed molten salt | 7 | 13 | 7 | 13 | 3 | 4 | 7 | 13 | 7 | 13 |
| Treatment | 400 | 400 | 400 | 400 | 400 | 400 | 400 | 400 | 400 | 400 |
| temperature (° C.) | | | | | | | | | | |
| Treating time (min.) | 120 | 120 | 120 | 120 | 120 | 120 | 120 | 120 | 120 | 120 |
| Preheating | — | — | — | — | — | — | — | — | — | — |
| Condition (° C.) | | | | | | | | | | |
| Annealing/quenching | 1500 | 1500 | 1500 | 1500 | 1500 | 1500 | 1500 | 1500 | 1500 | 1500 |
| condition (° C./min.) | | | | | | | | | | |
| K_{c} (MPa · m^{1/2}) | 1.91 | 1.35 | 0.66 | x | 1.1 | 0.58 | x | x | 1.12 | 0.47 |
| K_{c}/K_{bulk} | 2.15 | 1.52 | 0.85 | — | 1.53 | 0.81 | — | — | 1.38 | 0.58 |
| Flatness (μm) | — | — | — | — | — | — | — | — | — | — |
| Wa (nm) | — | — | — | — | — | — | — | — | — | — |

TABLE 10

| | Example | | | | | | | | | |
|---|---|---|---|---|---|---|---|---|---|---|
| | 31 | 32 | 33 | 34 | 35 | 36 | 37 | 38 | 39 | 40 |
| Glass for a substrate | 9 | 9 | 10 | 10 | 10 | 11 | 11 | 11 | 12 | 12 |
| Mixed molten salt | 6 | 7 | 6 | 7 | 12 | 6 | 7 | 12 | 6 | 7 |
| Treatment | 400 | 400 | 400 | 400 | 400 | 400 | 400 | 400 | 400 | 400 |
| temperature (° C.) | | | | | | | | | | |
| Treating time (min.) | 120 | 120 | 120 | 120 | 120 | 120 | 120 | 120 | 120 | 120 |
| Preheating | — | — | — | — | — | — | — | — | — | — |
| Condition (° C.) | | | | | | | | | | |
| Annealing/quenching | 1500 | 1500 | 1500 | 1500 | 1500 | 1500 | 1500 | 1500 | 1500 | 1500 |
| condition (° C./min.) | | | | | | | | | | |
| K_{c} (MPa · m^{1/2}) | 1.84 | 1.35 | 1.95 | 1.45 | 1.51 | 1.91 | 1.59 | 1.32 | 1.73 | 1.37 |
| K_{c}/K_{bulk} | 2.16 | 1.59 | 2.35 | 1.75 | 1.82 | 2.20 | 1.83 | 1.52 | 1.97 | 1.56 |
| Flatness (μm) | — | — | — | — | — | — | — | — | — | — |
| Wa (nm) | — | — | — | — | — | — | — | — | — | — |

TABLE 11

| | Example | | | | | | | | | | |
|---|---|---|---|---|---|---|---|---|---|---|---|
| | 41 | 42 | 43 | 44 | 45 | 46 | 47 | 48 | 49 | 50 | 51 |
| Glass for a substrate | 12 | 13 | 13 | 14 | 14 | 15 | 15 | 15 | 16 | 16 | 16 |
| Mixed molten salt | 10 | 7 | 12 | 6 | 7 | 6 | 7 | 12 | 6 | 7 | 12 |
| Treatment | 400 | 400 | 400 | 400 | 400 | 400 | 400 | 400 | 400 | 400 | 400 |
| temperature (° C.) | | | | | | | | | | | |
| Treating time (min.) | 120 | 120 | 120 | 120 | 120 | 120 | 120 | 120 | 120 | 120 | 120 |
| Preheating | — | — | — | — | — | — | — | — | — | — | — |
| Condition (° C.) | | | | | | | | | | | |
| Annealing/quenching | 1500 | 1500 | 1500 | 1500 | 1500 | 1500 | 1500 | 1500 | 1500 | 1500 | 1500 |
| condition (° C./min.) | | | | | | | | | | | |
| K_{c} (MPa · m^{1/2}) | 1.25 | 0.96 | 0.97 | 2.44 | 2.19 | 1.7 | 1.5 | 1.34 | 2.24 | 1.73 | 1.52 |
| K_{c}/K_{bulk} | 1.42 | 1.19 | 1.20 | 2.74 | 2.46 | 2.00 | 1.76 | 1.58 | 2.33 | 1.80 | 1.58 |
| Flatness (μm) | — | — | — | — | — | — | — | — | — | — | — |
| Wa (nm) | — | — | — | — | — | — | — | — | — | — | — |

As seen from Tables 7 and 8, in Examples 6 to 9, 14 and 15 according to the present invention, the K_{c} value was 1.2 MPa·m^{1/2} or more, K_{c}/K_{bulk} was 1.2 or more, and the flatness was 3 μm or less. Also, in Examples 6, 7, 14 and 15, the arithmetic average waviness (Wa) was 0.6 nm or less.

On the other hand, as shown in Tables 7 and 8, in Example 1 which is Comparative Example, the K_{c} value was less than 1.2 MPa·m^{1/2}, and in Examples 2 to 5, Wa was more than 0.6 nm. Also, in Examples 10 to 13 of Tables 7 and 8, the K_{c} value was less than 1.2 MPa·m^{1/2}, and in Examples 11 to 13, K_{c}/K_{bulk} was less than 1.2.

These results reveal that when the mixed molten salt contains from 1 to 7.5 mass % of lithium nitrate, both K_{c} and flatness of the glass for a substrate and glass disk can be satisfied. It is considered that ion exchange was accelerated by the addition of lithium nitrate and the stress distribution in the plane became uniform, as a result, deterioration of the flatness was suppressed.

Also, as seen from Tables 8 to 11, in Examples 21, 22, 31 to 41 and 44 to 51 according to the present invention, the K_{c} value was 1.2 MPa·m^{1/2} or more and K_{c}/K_{bulk} was 1.2 or more.

On the other hand, in Examples 16 to 20, 23 to 30, 42 and 43 of Tables 8 to 11, which are Comparative Examples, the K_{c} value was less than 1.2 MPa·m^{1/2} or due to formation of a tensile layer as the surface layer during chemical strengthening or cleaning, self-fracture occurred, and the measurements could not be performed. Also, in Examples 16 to 19, 23, 26, 30 and 42, K_{c}/K_{bulk} was less than 1.2.

These results reveal that even when glass having a glass composition in which the content of Li₂O is, in terms of mol % on the basis of oxides, less than 7% and Li₂O+Na₂O is less than 13%, is subjected to a chemical strengthening treatment by using a mixed molten salt containing from 1 to 7.5 mass % of lithium nitrate, sufficient strength is not obtained. Furthermore, it is revealed that sufficient strength is not obtained also in the glass where the content of Al₂O₃ is less than 9%.

While the invention has been described in detail with reference to specific embodiments thereof, it will be apparent to one skilled in the art that various changes and modifications can be made therein without departing from the spirit and scope thereof.

Incidentally, the present application is based on Japanese Patent Application No. 2009-278572 filed on Dec. 8, 2009, and the contents are incorporated herein by reference.

All references cited herein are incorporated by reference herein in their entirety.

Also, all the references cited herein are incorporated as a whole.

The manufacturing method of a glass substrate for data storage mediums of the present invention can be utilized for a data recording medium, a substrate thereof, and their manufacture.

What is claimed is:

1. A method for manufacturing a glass substrate for data storage mediums, said method comprising a chemical strengthening treatment step of dipping a glass for a substrate comprising, in terms of mol % on the basis of oxides, from 58 to 66% of SiO₂, from 9 to 15% of Al₂O₃, from 7 to 15% of Li₂O and from 2 to 9% of Na₂O, provided that Li₂O+Na₂O is from 13 to 21%, in a mixed molten salt to form a compressive layer on front and back surfaces of said glass for a substrate,
wherein the mixed molten salt comprises, in terms of mass percent, from 1 to 7.5% of lithium nitrate, from 28 to 55% of sodium nitrate and from 40 to 69% of potassium nitrate.

2. The method for manufacturing a glass substrate for data storage mediums according to claim 1, wherein said glass for a substrate subjected to said chemical strengthening treatment has:
a fracture toughness value K_{c} measured by an IF method in accordance with JIS R1607 of 1.2 MPa·m^{1/2} or more;
a value K_{c}/K_{bulk} obtained by dividing the fracture toughness value K_{c} by a fracture toughness value K_{bulk} measured by the IF method before subjecting the chemical strengthening treatment of 1.2 or more;
a flatness of 3 μm or less; and
an arithmetic average waviness (Wa) with cutoff values of 0.4 mm and 5 mm on a surface between a radius of 16 mm and a radius of 28 mm from a center of a 2.5-inch disk of said glass for a substrate, of 0.6 nm or less.

3. A glass substrate for data storage mediums, manufactured by the manufacturing method according to claim 1.

4. A data storage medium comprising the glass substrate for data storage mediums according to claim 3 and a magnetic recording layer formed on said glass substrate.

5. A glass substrate for data storage mediums, manufactured by the manufacturing method according to claim 2.

6. A data storage medium comprising the glass substrate for data storage mediums according to claim 5 and a magnetic recording layer formed on said glass substrate.
